(19) United States
(12) Patent Application Publication
(10) Pub. No.: US 2026/0147375 A1
(43) Pub. Date: May 28, 2026

(54) LOW LATENCY PCIE RETIMER WITH SKEW CORRECTION

(71) Applicant: Kandou Labs SA, Saint-Sulpice (CH)

(72) Inventors: Alexander Koch Koch; Peter Korger Korger

(73) Assignee: Kandou Labs SA, Saint-Sulpice (CH)

(21) Appl. No.: 19/122,067

(22) PCT Filed: Oct. 18, 2023
(86) PCT No.: PCT/US23/77207

§ 371 Date: Apr. 17, 2025

Related U.S. Application Data
(60) Provisional application No. 63/380,043, filed on Oct. 18, 2022.
(60) Provisional application No. 63/385,570, filed on Nov. 30, 2022.

(51) Int. Cl. G06F 1/10; G06F 1/12; G06F 5/06

(52) U.S. Cl. CPC G06F 1/10; G06F 1/12; G06F 5/065

(57) ABSTRACT

Methods and systems are described for calculating lane-to-lane skew parameters from detected alignment symbols during a skew measurement mode of operation, detecting a command to switch from skew measurement mode to a transparent mode of operation, wherein each of the plurality of encoded data streams are routed to respective low-latency CDC FIFOs configured to store the encoded data streams using respective write clocks and to output encoded data streams based on corresponding read clocks, each read clock synchronized to a corresponding write clock, and adjusting a timing of a first encoded data stream relative to a second encoded data stream based on the set of lane-to-lane skew parameters generated in the PCS to reduce lane-to-lane skew.

### CROSS-REFERENCE TO RELATED APPLICATIONS

This application claims the benefit of U.S. Application No. 63/380,043, filed Oct. 18, 2022, entitled “LOW LATENCY PCIE RETIMER WITH SKEW CORRECTION”, and claims the benefit of U.S. Application No. 63/385,570, filed Nov. 30, 2022, entitled “LOW LATENCY PCIE RETIMER WITH SKEW CORRECTION”, which are hereby incorporated herein by reference in its entirety for all purposes.

### REFERENCES

The following references are herein incorporated by reference in their entirety for all purposes:

U.S. Pat. No. 9,965,439, issued May 8, 2018, naming Das Sharma, entitled “Low Latency Multi-Protocol Retimers”, herein referred to as [Sharma].

### BACKGROUND

With increased data rate in PCIe 5.0 (32 Gbps) compared to previous generations (e.g., PCIe 4.0 MAX 16 Gbps), the channel reach becomes even shorter than before, and the need for retimers becomes more evident. Typical channels comprise system boards, backplanes, cables, riser-cards and add-in cards. Connections across these kinds of channels—often combinations of these channels and their sockets—usually have losses that exceed the specified target loss of −36 dB at 16 GHz. Retimers extend the channel reach to get across the border to what is possible without a retimer.

Retimers break a link between a host (root complex, abbreviated RC) and a device (end point) into two separate segments. Thus, a retimer re-establishes a new PCIe link going forward, which includes re-training and proper equalization implementing the physical and link layer.

While redrivers are pure analog amplifiers that boost the signal to compensate for attenuation, they also boost noise and usually contribute to jitter. Retimers instead comprise analog and digital logic. Retimers equalize the signal, retrieve their clocking, and output a signal with high amplitude and low noise and jitter. Furthermore, retimers maintain power states to keep system power low.

Retimers were first specified in PCIe 4.0. For PCIe 5.0, the usage of retimers is expected. FIG. 1A and FIG. 1B show typical applications for retimers, in accordance with some embodiments. In FIG. 1A, one retimer is employed. The retimer is located on the motherboard, and logically the retimer is between the PCIe root complex (RC) and the PCIe endpoint.

FIG. 1B shows the usage of two retimers. The first retimer is similarly located on the motherboard, while the second retimer is on a riser card which makes the connection between the motherboard and the add-in card containing the PCIe endpoint.

In complex PCIe systems, the number of PCIe endpoints can be significantly higher than the number of free PCIe ports. In such scenarios, switch devices may be used to extend the number of PCIe ports. Switches allow for connecting several endpoints to one root point, and for routing data packets to the specified destinations rather than simply mirroring data to all ports. One important characteristic of switches is the sharing of bandwidth, as all endpoints share the bandwidth of the root point.

### BRIEF DESCRIPTION

Methods and systems are described for decoding a plurality of encoded data streams associated with respective lanes of a data link and storing each decoded data stream in corresponding PCS-mode FIFOs configured to perform lane deskew and rate adaptation on the decoded data streams, detecting alignment symbols in each of the plurality of decoded data streams, and synchronously setting read pointers of each lane to positions corresponding to the detected alignment symbols, calculating a set of lane-to-lane skew parameters based at least in part on latency of each PCS-mode FIFO, the latency of each PCS-mode FIFO associated with read pointer location with respect to a corresponding write pointer, detecting a command to switch from PCS-mode used for skew measurement to a transparent mode of operation, wherein each of the plurality of encoded data streams are routed to respective low-latency CDC FIFOs configured to store the encoded data streams using respective write clocks and to output encoded data streams based on corresponding read clocks, each read clock synchronized to a corresponding write clock, and adjusting a timing of a first encoded data stream relative to a second encoded data stream based on the set of lane-to-lane skew parameters generated in the PCS-mode to reduce lane-to-lane skew.

This Brief Summary is provided to introduce a selection of concepts in a simplified form that are further described below in the Detailed Description. This Brief Summary is not intended to identify key or essential features of the claimed subject matter, nor is it intended to be used as an aid in determining the scope of the claimed subject matter. Other objects and/or advantages of the present invention will be apparent to one of ordinary skill in the art upon review of the Detailed Description and the included drawings.

### BRIEF DESCRIPTION OF FIGURES

FIGS. 1A and 1B illustrate two usages of retimers, in accordance with some embodiments.

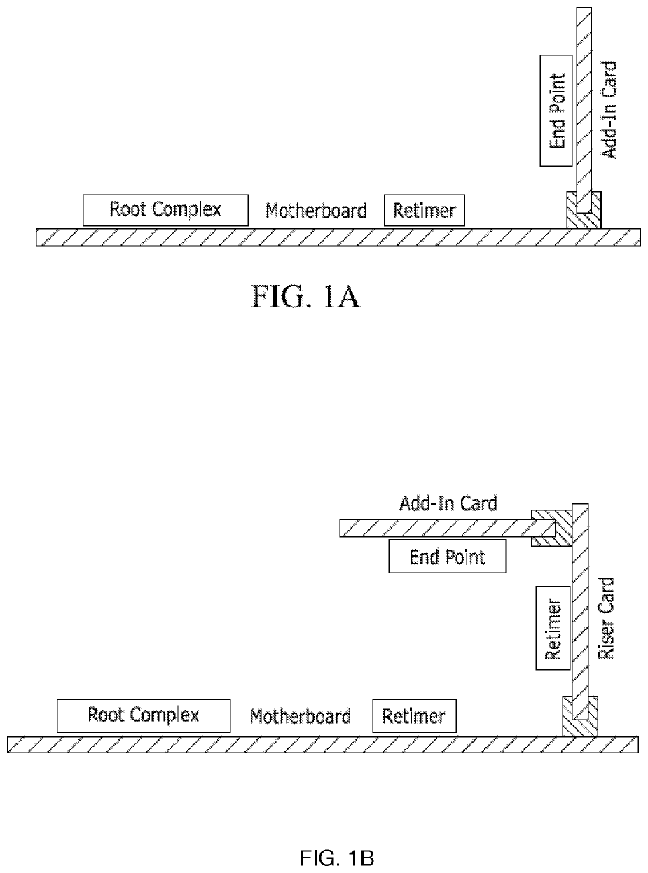

FIG. 2 illustrates the bit-level retimer data path through the PCIe retimer.

FIG. 3 is a block diagram illustrating of a bit-level retimer data path.

FIG. 4 is a block diagram of a CDC buffer, in accordance with some embodiments.

FIG. 5 is a timing diagram illustrating write and read clocks being in-phase and out-of-phase.

FIG. 6 is a flow diagram of a state machine, in accordance with some embodiments.

FIG. 7 is a block diagram and timing diagram for a CDC buffer, in accordance with some embodiments.

FIG. 8 illustrates a PCS retimer data path through the PCIe retimer.

FIG. 9 is a block diagram illustrating the PCS retimer data path in more detail.

FIG. 10 is a block diagram illustrating an alternative implementation of the PCS retimer data path.

FIG. 11 is a block diagram illustrating a third implementation of the PCS retimer data path, in accordance with some embodiments.

FIG. 12 is a block diagram of PCS block structure for a given lane, in accordance with some embodiments.

FIG. 13 is a block diagram of a multi-lane deskew circuit, in accordance with some embodiments.

FIG. 14 is a block diagram of a crossbar multiplexer, in accordance with some embodiments.

FIG. 15 is a block diagram illustrating an environment with multiple PCIe retimer chips between a root complex and an endpoint, in accordance with some embodiments.

FIG. 16 is a block diagram of another environment having multiple PCIe retimer chips between a root complex and an endpoint, in accordance with some embodiments.

FIG. 17 is a block diagram illustrating a delay selection circuit for performing multi-lane deskew in bit-level retimer mode, in accordance with some embodiments.

FIG. 18 is a flowchart of a method, in accordance with some embodiments.

### DETAILED DESCRIPTION

Despite the increasing technological ability to integrate entire systems into a single integrated circuit, multiple chip systems and subsystems retain significant advantages. For purposes of description and without limitation, example embodiments of at least some aspects of the invention herein described assume a systems environment of at least one point-to-point communications interface connecting two integrated circuit chips representing a root complex (i.e., a host) and an endpoint, (2) wherein the communications interface is supported by several data lanes, each composed of four high-speed transmission line signal wires.

Retimers typically include PHYs and retimer core logic. PHYs include a receiver portion and a transmitter portion. A PHY receiver recovers and deserializes data and recovers the clock, while a PHY transmitter serializes data and provides amplification for output transmission. The retimer core logic performs deskewing (in multi-lane links) and rate adaptation to accommodate for frequency differences between the ports on each side.

Since the retimer is located on the path between a root complex (e.g., a CPU) and an end point (e.g., a cache block) the retimer adds additional value. An integrated processing unit, e.g., an accelerator, may be integrated into the retimer performing data processing on the path from the root complex to the end point.

To allow for a highly flexible solution, the PCIe retimer has normal PHY interfaces towards the PCIe bus and a high-speed die-to-die interconnect towards a data processing unit (DPU). The high-speed die-to-die interconnect allows for very high-speed communication links between chiplets in the same package. The PCIe retimer circuit is a chiplet, a die, with a four-lane retimer and the capability to connect to a DPU chiplet via the high-speed die-to-die interconnect. One, two or four lanes can be bundled into a multi-lane link where data is spread across all the links. It is also possible to configure each lane individually to form a single-lane link. In the PCIe retimer, each lane employs two PHYs, one on each end (up-and downstream ports). Considering four lanes, eight PHYs are used in one PCIe retimer die. The PCIe retimer die also contains communication lines which allow for exchanging control information between two or more PCIe retimer dies.

The following can be built using one (or more) PCIe retimer chiplet(s). These are discussed in more detail below:
4-lane retimer
Single die, with full flexible 4×4 static lane routing
4-lane retimer with accelerator (DPU)
Two dies in one package, a retimer die and a DPU die
8-lane retimer
Two dies in one package, limited static lane routing-flexible 4×4 routing on same die but no data crossing die boundaries
8-lane retimer with full flexible lane routing
Two dies in one package, data crossing chiplets are routed through high-speed die-to-die interconnect at the cost of additional delay.
8-lane retimer with accelerator (DPU)
Three dies in package, two retimer dies and a DPU die
16-lane retimer
Four dies in one package, limited static lane routing—flexible 4×4 routing on same die but no data crossing die boundaries

### PCIe Retimer Chiplet

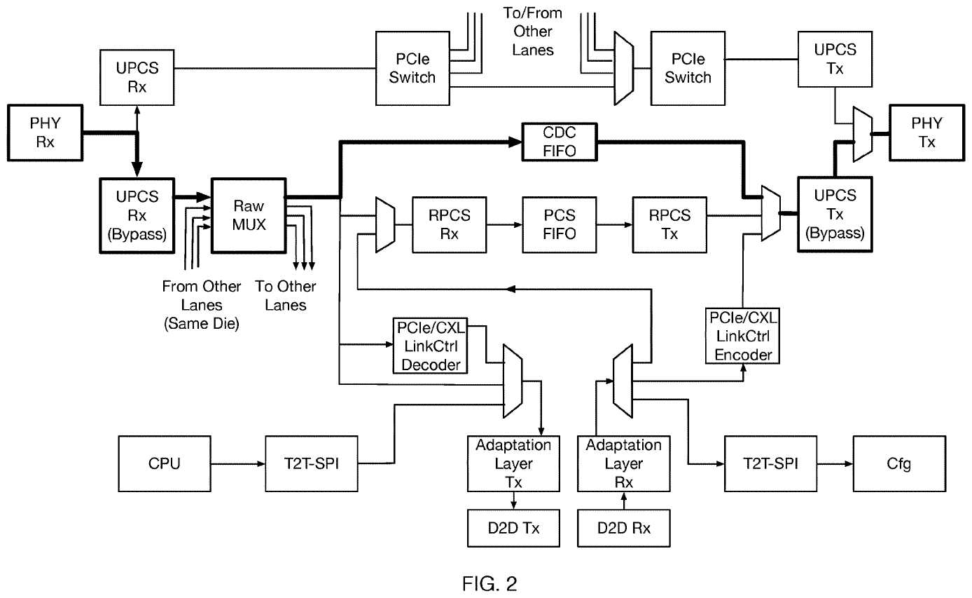

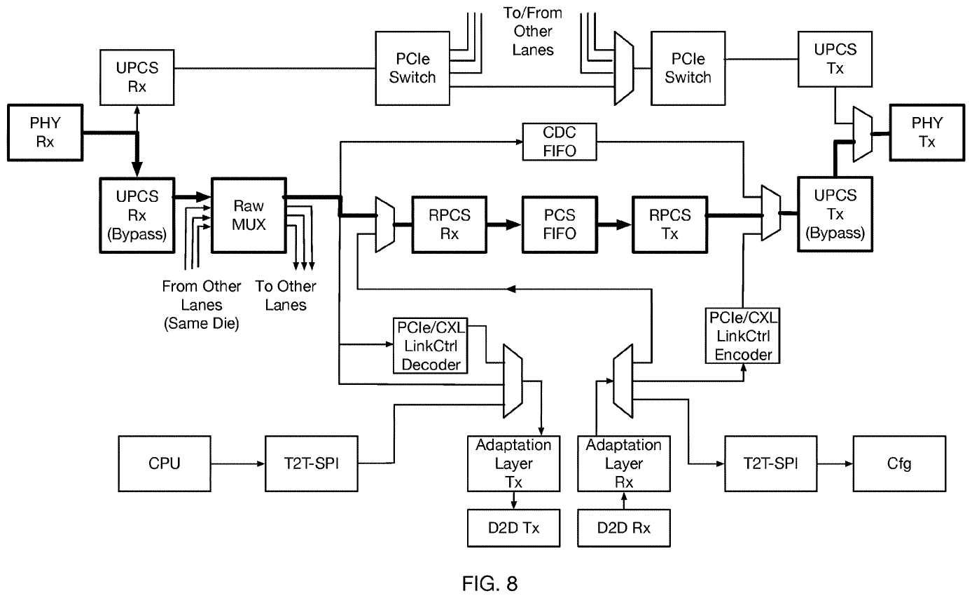

FIG. 2 is a block diagram of a PCIe retimer chiplet configurable to operate in numerous modes, including transparent (i.e., raw mode, shown) and physical coding sublayer (PCS) retimer mode, which is described in more detail below and with respect to FIG. 8.

As shown, FIG. 2 includes a PHY, which is the physical layer of a communication system. In the PCIe retimer, the PHYs include Serializers and Deserializers accompanied by controlling logic. The PHY itself is data agnostic. In PCIe 5.0 mode, the PHYs handle a bandwidth of up to 32 Gbps. The serial side is NRZ encoded with no additional clock signal. The parallel side has a bit-width of 32 and is accompanied with a clock with a frequency of maximum 1 GHz.

The physical coding sublayer (PCS) is responsible for encoding raw data into a form to allow for recovering clock information. Thus, data is mapped to data having a high transition density. For PCIe 2.5 Gbps and 5 Gbps modes, an 8b/10b encoding is used. For higher data rates (8 Gbps, 16 Gbps, and 32 Gbps) a 128b/130b encoding is employed. The PCS is also responsible for generating (TX) and checking (RX) training sequences to train the receiver part of a PHY. The PCS is also involved in lane-to-lane deskewing and—if required—rate adaptation (RX). Lane deskew is described in more detail below. The PCS is controlled by a link training and status state machine (LTSSM) or specifically in retimer mode, by a retimer training and status state machine (RTSSM), which is usually not included in the PCS. The block diagram of FIG. 2 includes a universal PCS (UPCS) and a retimer PCS (RPCS).

The UPCS is configurable to operate in two modes: in physical interface for PCI Express (PIPE) mode or in serdes PIPE mode. The serdes PIPE mode is used to connect to the retimer PCS, and no data processing is performed, effectively acting as a bypass. The PIPE mode (i.e., classic PIPE mode) is used when connecting to the PCIe switch and the link controller. In classic PIPE mode, either the 8b10b or 128b130b encoding is employed, as well as lane deskew and rate adaptation.

The UPCS in classic PIPE mode does not meet the required 64ns/128ns maximum latency requirements defined in PCIe, and thus the RPCS is implemented to perform lane deskew and rate adaptation as described in more detail below.

FIG. 2 further includes a link controller. The link controller implements the data link layer and transaction layer for PCIe as well as for compute express link (CXL) packets. An arbiter inside the link controller differentiates between both modes and distributes packets for further decoding/encoding appropriately. In an exemplary PCIe retimer chip, eight link controllers are included to support bifurcation. In one such embodiment, the following eight link controllers are employed:
One 8-lane link controller (this link controller can also be used for links composed of only one, two or four lanes)
One 4-lane link controller (this link controller can also be used for links composed of only one or two lanes)
Two 2-lane link controllers (allows also for operating in single lane mode)
four 1-lane link controllers.

FIG. 2 further includes a Raw multiplexer (MUX). The Raw MUX is an 8*8 mux, which is statically configurable. Each port of the 8*8 mux includes a 32-bit data bus accompanied with clock and reset signal. In some embodiments, additional signals may be switched in addition to data, clock and reset. Each data bus is 32-bit wide and matches the parallel PHY interface. The eight inputs and eight outputs have the same interface (bit width, signals). Each output port is connected to an input port. In some embodiments, one input port is connected to exactly one output port. In alternative embodiments, the raw MUX may be configurable for port mirroring where one input port is connected to more than one output port.

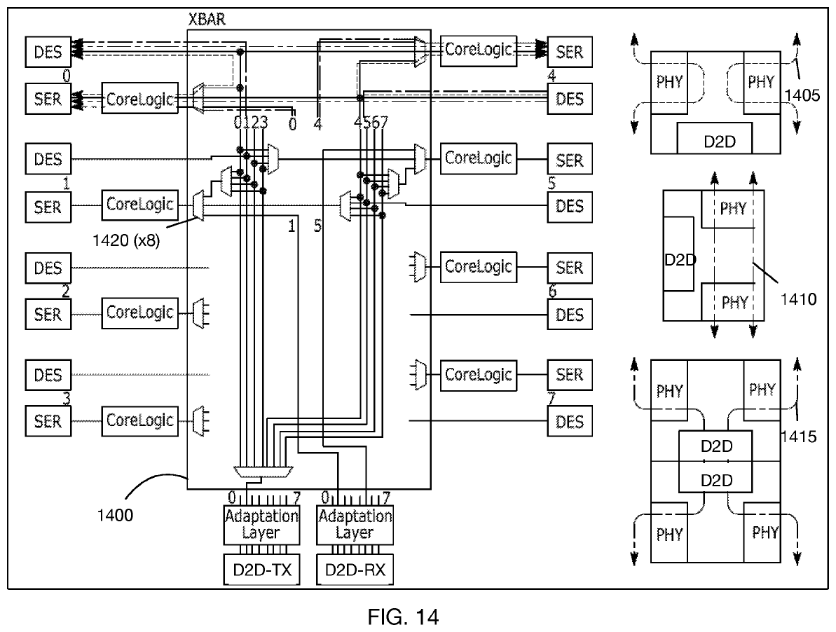

FIG. 14 is a block diagram of a raw MUX, in accordance with some embodiments. As shown, the raw mux interfaces in between the receiver portion of the PHY and the core logic, which includes e.g., the RPCS logic and the link controller logic. In the top right diagram data is fed in at top side, passes into the PHY and through the core logic and through the same PHY down to the bottom. In the middle diagram the data is fed in at the top, processed in the core logic and fed out at the opposite PHY on the bottom. Finally, in the bottom drawing, all data is fed into the PHYs at the top side of one PCIe retimer circuit and from there directly forwarded to the high-speed die-to-die interconnect. From there data is fed through the core logic and then to the PHYs on the bottom side of the other PCIe retimer die. In all such scenarios, there are data paths in the opposite direction as well.

FIG. 14 is a block diagram of a lane switching multiplexer (MUX), also referred to herein as a crossbar switch 1400 for lane routing in a retimer circuit die of an ICM, in accordance with some embodiments. FIG. 14 includes a block diagram on the left and various lane routing configurations on the right. In the top lane routing configuration 1405, data is fed in through a deserializer, passes into the PHY and through the core logic and through the same PHY and output via the serializer down to the bottom. In the middle diagram 1410, the data is fed into one port, processed in the core logic and fed out at the opposite PHY on the bottom. Finally, in the bottom drawing 1415, all data is fed into the PHYs at the top side of one PCIe retimer circuit and from there directly forwarded to the high-speed die-to-die interconnect. From there data is fed through the core logic and then to the PHYs on the bottom side of the other PCIe retimer die. In all such scenarios, there are data paths in the opposite direction as well.

On the left side of FIG. 14, a sketch of the Raw MUX logic is shown. The serial data transceiver PHYs are numbered from 0 to 7 and include receiver deserializers (DES) and transmitter serializers (SER). The top lane (PHY #0 and #4) illustrates the three different data paths matching the data paths shown on the right. Data path 1405 on the right corresponds to data coming in on PHY 0 of the PCIe retimer circuit leaving on the same PHY #0 on the left-hand side of FIG. 14. Path 1410 shows a feed-through path where data received on PHY 0 passes through to PHY #4 as shown on the left-hand side of FIG. 14. Finally, path 1415 indicates that all received data is directly forwarded to adaptation layer to be transmitted over the inter-die data interface. On the second PCIe retimer, data from the inter-die data interface is forwarded to the core logic, where it is processed and output on the attached PHY.

The second lane (PHY #1 and #5) indicate the multiplexing capabilities. Each core-logic/transmitter path can receive data from each of the eight lanes. Additionally, data can be obtained from the inter-die data interface. The other lanes (PHY #0 with #4, PHY #2 with #6 and PHY #3 with #7) have the same switching capabilities. On the bottom, the multiplexing for one lane to the inter-die data interface is shown. Any input PHY can be select for each lane entering the high-speed die-to-die interconnect. Thus, some embodiments may mirror data by selecting the same received PHY data for multiple adaptation layer physical ports. Details on port mirroring embodiments are described in more detail below.

Switching a data path in the Raw MUX includes the 32-bit received data bus carrying the deserialized lane-specific data words, accompanying data enabled lines, the recovered clock, and the corresponding reset. It is important to note that only raw data is multiplexed, the received data is not processed in any way. The Raw MUX logic is statically configured via configuration bits, the switching itself happens asynchronously. In case the Raw MUX settings are changed during mission mode, invalid data and glitches on the clock lines are likely. Thus, it is recommended to change the multiplexing logic setup during reset.

### Transparent Mode

The raw or transparent mode allows for routing data lanes statically from any input lane to any output lane on the same die. The data paths are data agnostic, which prevents any deskewing capabilities within bit-level retimer mode alone. Embodiments described herein combine the deskew functionality of the PCS retimer mode with the bit-level retimer mode to compensate for lane skew prior to the data reaching the endpoint, thus reducing the required buffer size in the endpoint. Since no data processing is done in transparent mode, this mode has a low amount of latency from input to output. In transparent mode, the transmit clock is synchronized to the recovered receive clock.

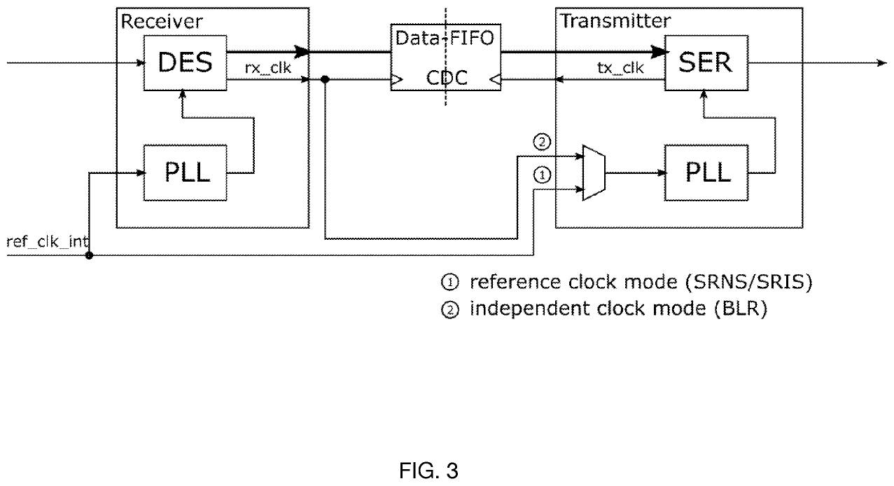

FIG. 3 is a block diagram of transparent mode, in accordance with some embodiments. As shown, information is deserialized in the PHY according to the recovered clock output from the phase-locked loop (PLL), passed through a clock domain crossing (CDC) first-in-first-out (FIFO) buffer, serialized in the PHY and output according to the transmit clock, which is synchronized according to the recovered receive clock. The PLL is clocked with the 100 MHz internal reference clock. The PLL generates the high-speed sampling clock for the receive data path. A clock-data recovery (CDR) adjusts the clock and synchronizes the sampling clock to the incoming data. The deserializers output a rx data clock (rx_clk) in parallel to the data which is used as a reference clock for the transmitter on the right side in transparent mode. The PLL in the transmitter generates the high-speed clock for the serializer and the serializer outputs a tx data clock (tx_clk) in parallel to the data. In transparent mode, the tx_clk is always synchronized to rx_clk. However, jitter between the two clocks demands for minimum logic in the CDC FIFO buffer. Two types of CDC FIFO buffers are described below.

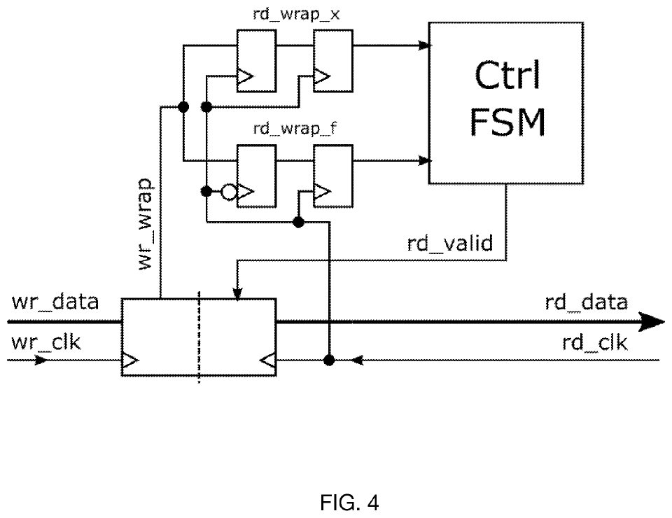

FIG. 4 is a block diagram of a first CDC FIFO buffer, in accordance with some embodiments. The CDC-logic includes a FIFO having a size of at least four words. The write side is clocked with the recovered read clock rx_clk (wr_clk) whereas the read side is clocked with transmit clock tx_clk (which is synchronized to rx_clk, rd_clk). The write pointer and read pointer start with an offset of two and maintain this distance permanently while incrementing to maintain stable read operations even in the case of jitter of plus or minus one clock cycle.

In the CDC FIFO of FIG. 4, the write pointer and read pointer start at the same time. However, the reset release time will vary between tx_clk and rx_clk which leads to different delays between the lanes of the same link. In a worst-case scenario, some lanes will show a delay of one clock cycle, other lanes will have a delay of two clock cycles and other lanes will have a delay of three clock cycles.

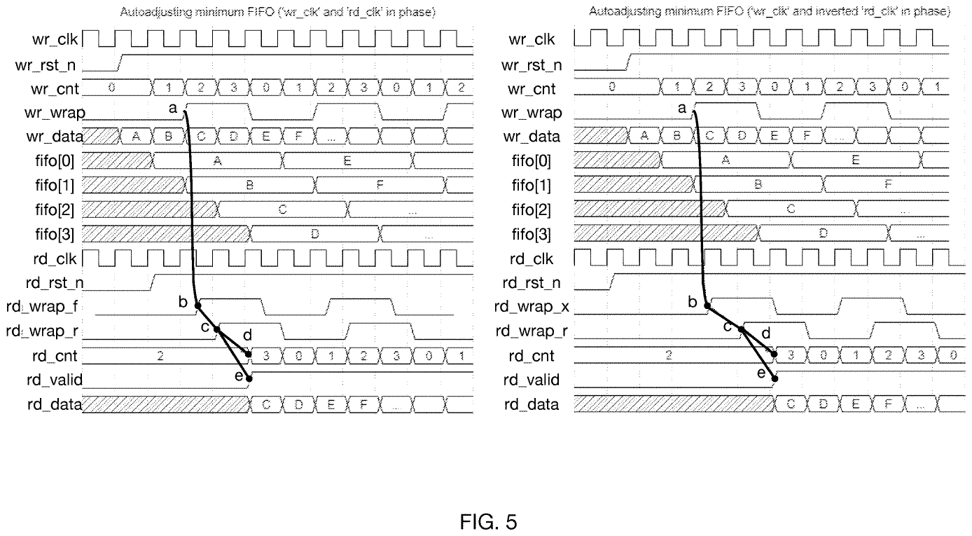

In at least one embodiment, the FIFO write and read pointers are synchronized after reset release to overcome the uncertainty between the read and write pointers. First, the FIFO fill level is of interest, and shows a fill level of two for all lanes. In doing so, the delay in each FIFO is the same. Typically calculating the fill level is difficult as write and read pointer operate on different clocks. In some embodiments, gray-coded counters are used. Knowing that both clocks have the same frequency and may only jitter a bit the calculation of the FIFO fill level can be made easier: Instead of synchronizing the FIFO write pointer to the read clock domain, only the MSB of the FIFO write pointer is synchronized, which indicates a pointer wrap. The MSB (i.e., ‘wr_wrap’ signal in FIG. 5) is stable for two clock cycles allowing for a secure synchronization into the read clock domain. The rising edge of the synchronized MSB can be used to set the read pointer appropriately.

Another uncertainty may be present if the phases of wr_clk (write side) and rd_clk (read side) are almost in phase (rising edges at the same time). In such a scenario, there is an uncertainty of one clock cycle after synchronization. A fixed delay of once clock cycle is achieved by clocking the first synchronization flop with the falling edge and the second synchronization flop with the rising edge. For the case where wr_clk and rd_clk are off by 180°, both synchronization flops are clocked on the rising edge, and a fixed delay of 1.5 clock cycles is achieved. FIG. 5 shows both cases: On the left side both clocks are in phase, on the right side the clocks are 180° out of phase.

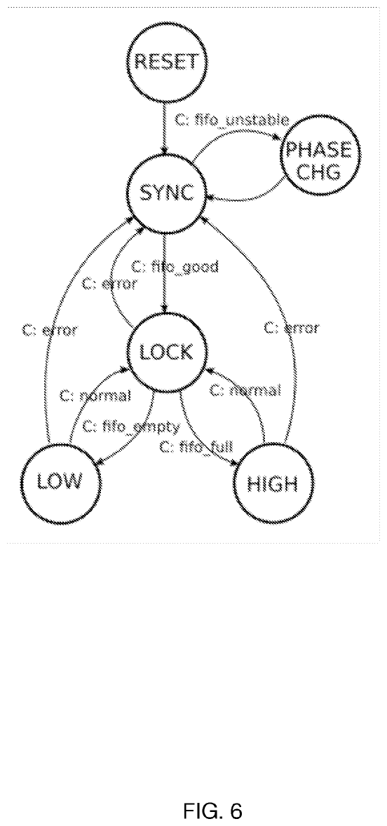

FIG. 4 includes a finite state machine (FSM), which may be employed to determine which sampling edge to use. A flow diagram illustrating the states of such a FSM is shown in FIG. 6, in accordance with some embodiments. After reset, the control FSM changes from the RESET state to the SYNC state and the wrap pulse ‘wr_wrap’ (MSB of the write pointer) is synchronized with a falling edge-clocked first flop and a rising edge-clocked second flop, indicated by rd_wrap_f and rd_wrap_r, respectively in the left timing diagram of FIG. 5. The first synchronized wrap pulse is used to set the FIFO read pointer initially. With every new occurring synchronized wrap pulse the FIFO read pointer is checked. If there is no change in the FIFO read pointer value after N cycles (N is programmable and in the range of 256 to 1024 or more), it is likely that both clocks are in phase and the control state machine changes from SYNC state into LOCK state. In the case that there are changes detected (i.e., FIFO read pointer varies during every check) it is likely that the two clocks are 180° out of phase. In such a scenario, the control FSM changes into PHASE_CHG state and the wrap synchronization edge-type is changed, and both synchronization flops begin to sample on the rising edge. In the right timing diagram: rd_wrap_x and rd_wrap_r).

After changing the synchronization edge-type, the control FSM goes back into SYNC state. The first synchronized wrap pulse initializes the read pointer again, and with every new synchronized wrap pulse the FIFO read pointer is checked. If there is no change in the FIFO read pointer value after N cycles again it is likely that the phases are in fact off by 180° and the right sampling edge for wrap is selected. The control state machine enters the LOCK state. In LOCK state, no change of the FIFO read pointer is permitted, however, the FIFO fill level is observed in order to detect drift.

To reduce stress on the first sampling FIFO, it may be useful to check every M-th wrap pulse. M is programmable, and can be in a range e.g., 64 to 256 in powers of two. On every active wrap pulse, the FIFO read pointer is checked again. When the FIFO read pointer is lower than expected for a longer time, the FIFO fill level is too low and state LOW is entered. In the opposite case, when the read pointer is higher than expected, state HIGH is entered. HIGH and LOW states are also considered as warning indications to the CPU system. When a HIGH or LOW state persists for a certain amount of time (L cycles, L programmable in the range of e.g., 1024 active checks), an error is issued. Depending on a configuration bit the control FSM either stays in the LOW/HIGH states or goes back to the SYNC state hunting for a new FIFO read pointer adjustment. When the FSM is in LOCK state and the read pointer approaches unexpectedly close to the write pointer, a further error condition is reached. The CPU is informed immediately as this does not indicate frequency drift but an internal error. In any case, when the FSM changes from LOCK, LOW or HIGH state into SYNC state again, an error symbol is inserted in the rd_data (FIFO read data) stream to make subsequent logic aware of unreliable data.

In some embodiments, the input of the unused synchronizer is disabled. In some embodiments, this can be done using an AND gate at the input. Alternatively, clock gating may be used for the synchronizer.

During simulation the first synchronization flop (rd_wrap_r or rd_wrap_f) are modeled in a way that the flop outputs random values (0 or 1) in case the input changes during flop setup-and hold-time. Setup-and hold-times are parameters of the flop. Modeling the first flop this way allows for deciding if the falling or rising edge shall be used for the first flop of the synchronization state.

In the case of spread spectrum clocking (SSC) it may be possible that the clock offset between rx and tx clock on the rising and falling slope of the SSC differ. The length of the synchronization phase may be extendable to cover a complete SSC period to find the best phase selection. In some embodiments, one SSC period lasts about 30 us. For a wrap every 2 ns this results in 15,000 wraps per SSC period. The synchronization phase may be configurable to allow for an observation of 2¹⁶ wrap pulses at most.

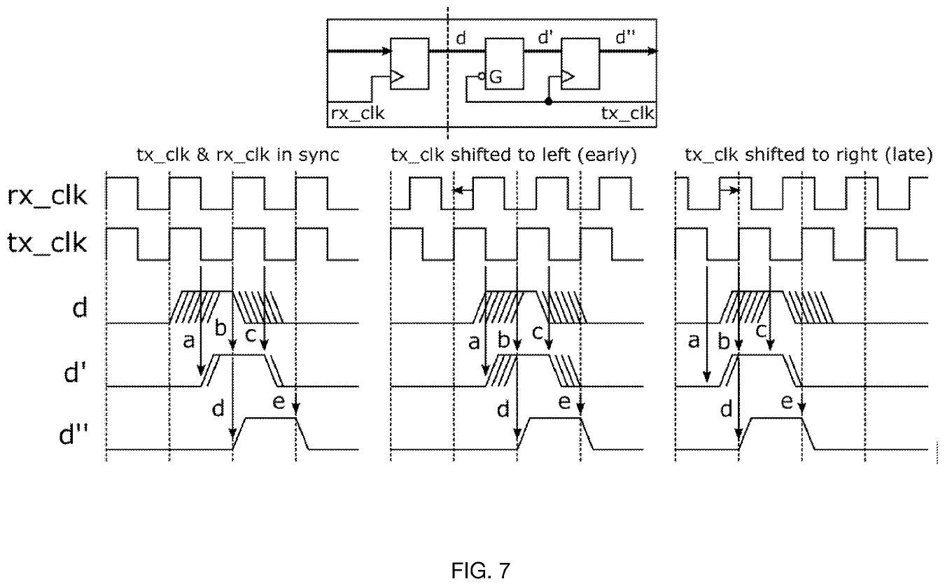

FIG. 7 is a schematic of a second CDC FIFO buffer, in accordance with some embodiments. A timing diagram is given as well. The CDC-logic includes a latch with inverted clock input and a flip-flop. The flip-flop on the left is used to allow for accurate timing. All elements of the CDC-logic are put as close as possible in synthesis to have enough margin for tx_clk jitter.

The timing diagram shows three cases. In the left timing diagram rx_clk and tx_clk are in phase, and data is securely transferred. In the middle timing diagram, the tx_clk is shifted to the right (i.e., earlier than rx_clk). In the right timing diagram tx_clk is shifted to the left (i.e., later than rx_clk). The arrows indicate special events. At (a) the latch opens when tx_clk is low. The latch is transparent, and all input data are visible at the latch's output. At (b) the latch closes when tx_clk becomes high. Data is stored and is stable. At (c) The latch opens a second time, and the next data enters the latch. At the rising edge of tx_clk, data from the latch is stored (d) in the Flop. With the next rising edge of tx_clk the next data from the latch is stored I in the flip-flop. In this transparent mode, tx_clk is synchronized to rx_clk in each lane independently. Since there will be skew between all recovered clocks (rx_clk) of a link, it is not practical to align the transmit clocks (tx_clk) of all lanes. This mode is therefore also named “lane independent mode”. It is recommended to use the same “phase detection logic” described above. For the case that the phases are off by 180°, the sampling logic may be inverted, followed by a flop clocked with non-inverted clock.

### Receive Clock Skew Reduction

Some embodiments may include a clock skew measurement circuit configured to measure the skew between the receive clocks (i.e., the lane-specific write clocks) to achieve sub-word lane-to-lane skew reduction. Due to the arbitrary slicing of serial data into “words” or “chunks” of 16 or 32 bits (or other sizes depending on selected bit-width W) by the deserializers in the PHY, there is a sub-word uncertainty of 0 to W-1 bits with respect to the latency between lanes. Since each lane operates independently, a retimer in transparent mode contributes to the lane-to-lane skew variation of 0 to N-1 bits between the lanes. Rx-clk skew reduction minimizes the additional skew introduced by the retimer in transparent mode itself. In at least one embodiment, a “bit slipping” concept may be utilized in which the receiver port of the serial data transceiver is slipped by one bit over several steps until the recovered clocks are in phase with each other. Thus, the latency through the receiver would be the same with an uncertainty of +/−1 unit interval.

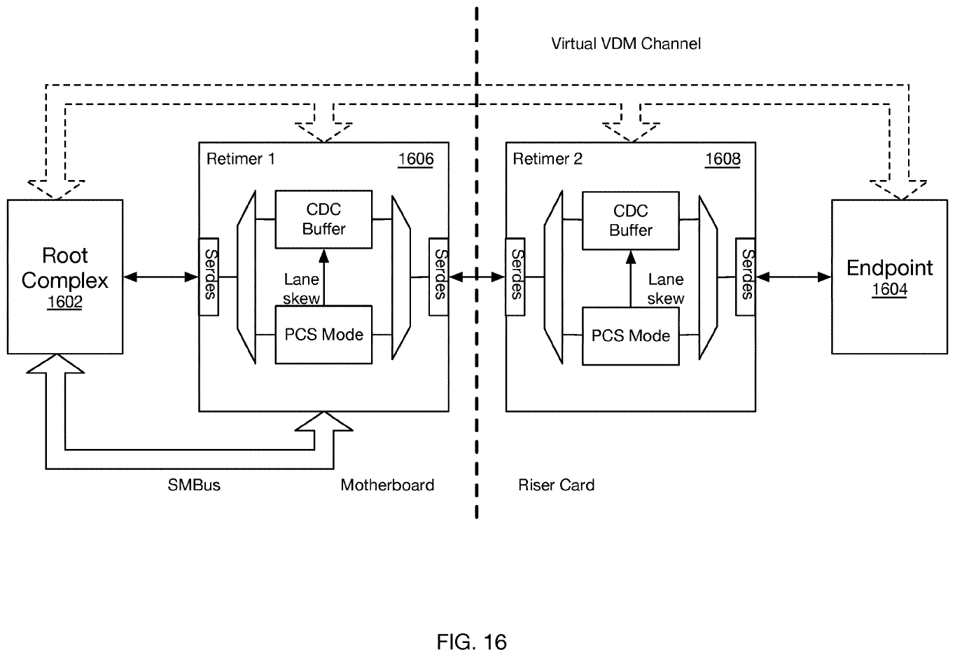

An alternative way to perform bit-level skew reduction involves measuring the skew of the clocks between two lanes (between a leader lane and all other lanes, follower lanes) and the number of measured UIs is compensated on the transmit side using a barrel shifter. The barrel shifter virtually adds skew: If all bits are shifted by one bit, the additional skew is 1 UI. Two possible methods for measuring skew are given below. While not explicitly shown in the transparent mode path of FIGS. 3, 11, and 16, it should be noted that such a barrel shifter may be included in the transparent mode path to increase the resolution of skew correction. In some embodiments, the receive portion of the PHY includes bit-slipping functionality as described above. In some embodiments, the transmit portion of the PHY includes a barrel shifter. In some embodiments, the barrel shifter may be implemented before/after the CDC FIFO or the delay buffer shown in FIG. 16.

A first method of measuring skew includes utilizing a delay line composed of a chain of inverters. The delay line is calibrated to the length of one clock cycle (1 GHZ). The delay between the rising edges of two clocks is measured and this delay is put in relation to the full clock cycle. The ratio is multiplied with the bit-width of the deserializer and this value is a rough value of the skew in UI between two lanes. In at least one example, the chain of inverters is 32 inverters long and calibrated such that the delay through the chain is Ins (i.e., a 1 GHz clock cycle). In such an implementation, each inverter output is on the resolution of a 32 GHz clock cycle. When one lane asserts that a full 32-bit word is ready, a flag signal may initiate the inverter chain and when a second lane asserts that a full 32-bit word is ready, the state of the inverter chain may be captured to see how many inverters flipped between the first and second lanes asserting that a full word is ready. Such an embodiment may be extended to support additional lanes as well.

A second method of measuring skew includes detecting sync-header bits, which are the leading two bits of ordered sets. The root complex outputs ordered sets in parallel and hence all sync-header bits are also output in parallel. The sync-header bits occur every 130 bits in 128b130b encoded data. However, this means that the sync-header bits do not fall into a power of two, thus looking at the receiver output the two sync header bits wander. However, it is possible to artificially add skew using a barrel shifter so that the sync-header bits are in parallel in all lanes. In such a method, lane-to-lane communications may occur.

After the skew is measured on a sub-word level, the skew may be adjusted in several ways. In at least one embodiment, the receive clock in the PHY of the faster lane that is used to clock data into the FIFO may be delayed using e.g., a delay line. In alternative embodiments, the transmit clock in the PHY of the faster lane may be similarly delayed. Some embodiments may utilize barrel shifters at the output of the FIFO.

### PCS Retimer Mode

FIG. 8 illustrates the PCS retimer path, in accordance with some embodiments. As shown, received data is decoded, processed, and encoded on the PCS layer. After decoding, the data across the lanes may be aligned on a block-level and lane-to-lane deskewing may be performed on a multi-lane link. Rate adaptation is also possible in the case of SRNS/SRIS mode by either inserting or removing skip symbols. Lane mapping (e.g., lane flipping) is possible when data stays on the same die. When deskewing/rate adaptation across several dies is required, deskew/rate adaptation information is exchanged. This may be done using slow-speed signals (˜100 MHZ) and adds additional latency.

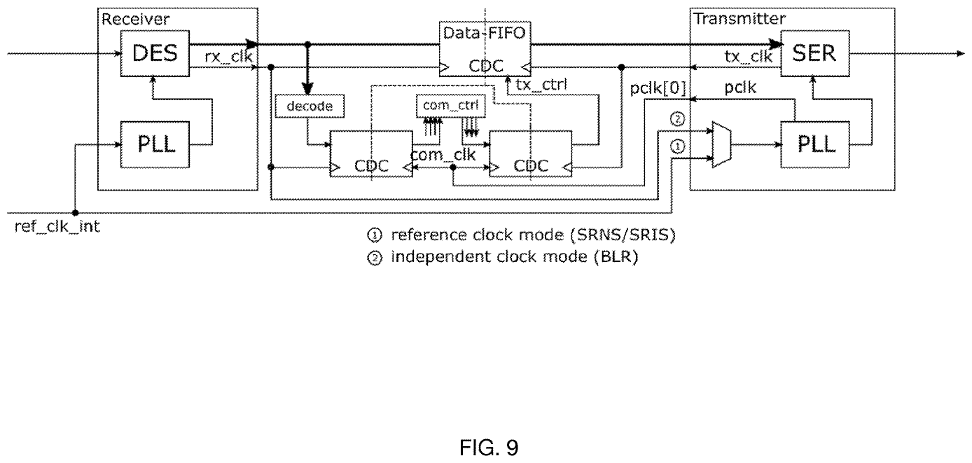

FIG. 9 is a block diagram of the PCS retimer portion of the PCIe retimer chiplet, including the PCS layer. In retimer mode, latency is minimized (albeit higher than the latency in transparent mode), the transmit clocks of each lane are synchronized to a common reference clock, the skew between lanes is minimized, and rate adaptation is performed. In FIG. 9, the receiver is shown on the left side. The RX-PLL is clocked with the 100 MHz internal reference clock (ref_clk_int). The PLL generates the high-speed sampling clock for the receive data path. A CDR adjusts the clock and synchronizes the sampling clock to the incoming data. The deserializer outputs a parallel rx data clock (rx_clk) which is used as a clock for the data fed into a Data-FIFO which is used for deskewing and rate-adaptation. The PLL in the transmitter (on the right side) generates a high-speed clock for the serializer and the serializer outputs a parallel tx data clock (tx_clk) which is used to read transmit data from the Data-FIFO. In addition, the transmitter outputs a common parallel clock (pclk). Both transmitter clocks (tx_clk and pclk) are synchronous to the mentioned common reference clock (ref_clk_int). Pclk from the transmitter of the first lane of a link is used as a common parallel clock (hence: pclk) for all lanes of the link.

In parallel to the data path there is logic controlling the deskewing and rate adaptation process. For this purpose, received data are fed into a decoder block. All information for deskewing and rate adaptation are extracted (alignment and skip ordered sets) from the received data stream. The control information is synchronized to the common clock ‘pelk’ and evaluated in a common control block. This block handles deskewing and rate adaptation centrally for all lanes. The resulting control information is synchronized to the transmit clock (tx_clk) and then used independently per lane to adjust the data-FIFO read pointer accordingly.

There are three clock domain crossings (CDC) in the PCS-based retimer mode. There is one central CDC for the data stream implemented as a FIFO. Data from the rx clk-domain is directly synchronized to the tx_clk domain independently for each lane. The control logic performs two clock domain crossings. First, received and extracted control information from each lane (rx_clk) is synchronized to an all lane spanning common clock (pclk). Common information is then synchronized to a lane based transmit clock (tx_clk) for final processing.

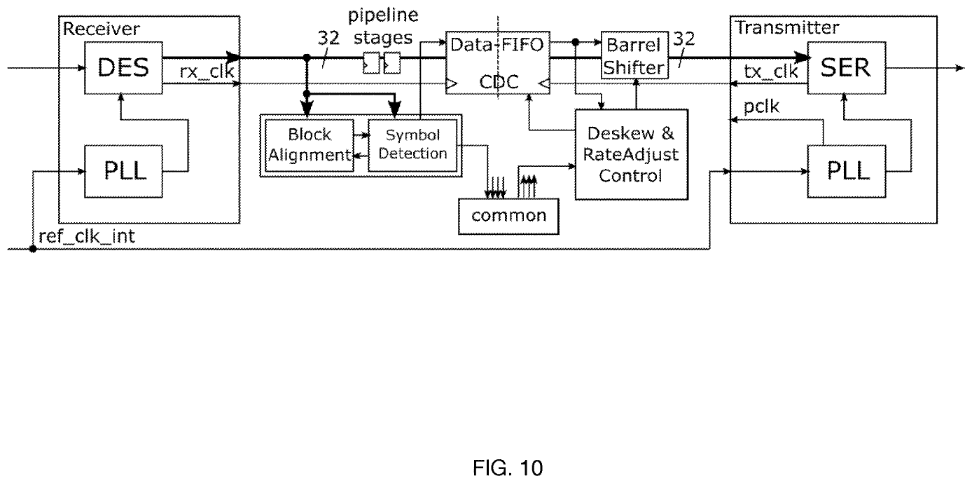

FIG. 10 illustrates a block diagram of a retimer operating in PCS mode for single and multi-tile implementations, in accordance with some embodiments. The PCS-mode FIFO may be configured to store encoded or decoded data. In the scenario the FIFO stores encoded data, data received at the PHY can be 8b10b or 128b130b encoded. The data is split into 16 or 32 bit chunks anywhere in the data stream. In this mode, received data is directly forwarded and stored in the FIFO. In parallel, data is also decoded with block detection and block alignment circuits. The block boundaries allowing exact location identification of an ordered set (i.e., a block) in the received data steam are stored as side-band information in the FIFO. To accommodate for processing delay during block alignment, pipeline stages may be added. After the FIFO, a barrel-shifter aligns blocks to a common start position in a deskewing process. The sync header bits are part of the data stream. A transfer to a transmitter can be done without further modification.

In the scenario the FIFO stores decoded data, received data is directly decoded into 8b or 128b chunks using block detection and alignment logic. Overhead information like control/data-type identifier (8b10b) or sync header information (start of block, type of ordered set, 128b130b) are extracted from the data but and stored together with the decoded data as sideband information in the FIFO. Data in the FIFO is aligned to ordered set boundaries by nature, and deskewing involves moving the FIFO read pointer to the appropriate location where the alignment symbols are stored. When forwarding FIFO read data to the transmitter, sync-header bits are inserted into the data stream again. Removing and inserting sync header bits typically results in idle cycles. It should be noted that regarding SKP ordered set insertion/removal, there is not much difference between the two modes in 128b130b mode. The incoming SKP ordered set will have a length of at least 12 symbols where the first eight symbols (64 bits) include identical bytes. 32 bits can be taken out of the eight symbols at any position.

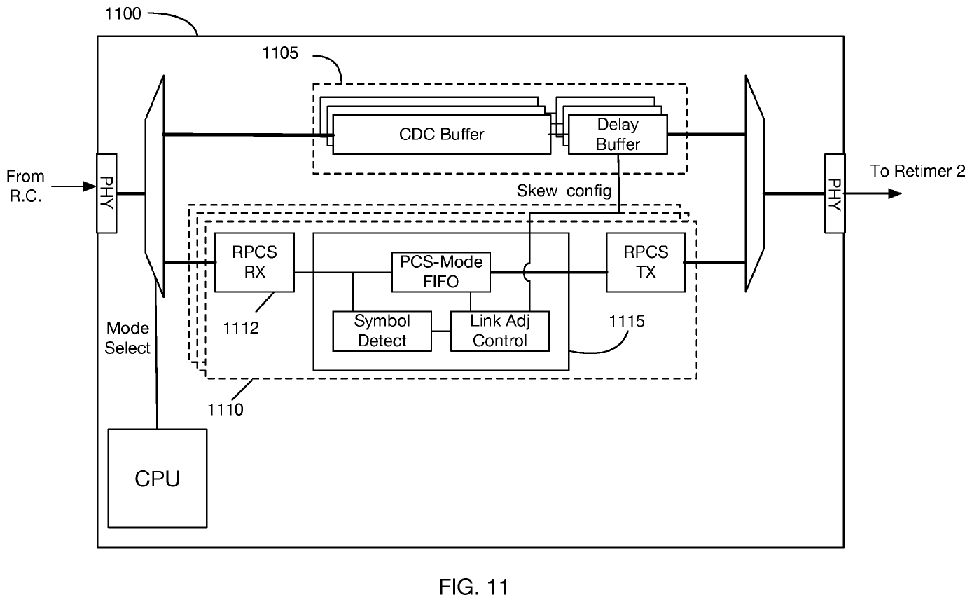

FIG. 11 is a block diagram of a retimer 1100, in accordance with some embodiments. As shown, FIG. 11 includes a transparent mode data path 1105 and a PCS retimer data path 1110 for a PCIe retimer circuit 1100, in accordance with some embodiments. Two possible solutions for transferring data from the receiver to the transmitter include the FIFO storing encoded data and the FIFO storing decoded data. The retimer 1100 is configured to reduce lane-to-lane skew in transparent mode of operation. Details on such skew reduction are given below.

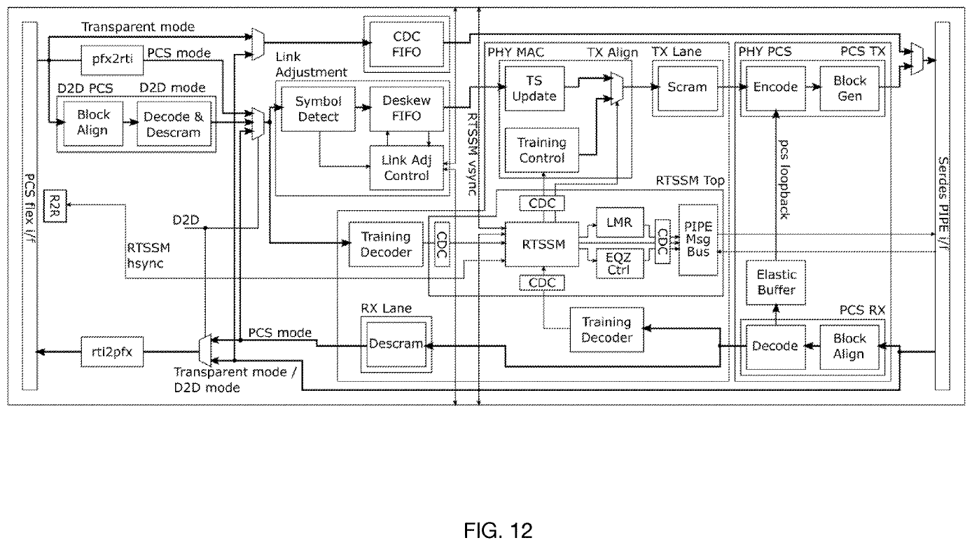

The retimer PCS (RPCS) logic for a data lane is shown in FIG. 12 and operates as follows. The RPCS logic includes a PHY PCS block and a PHY MAC block. In the RX direction, data is split into an 8b10b path (for PCIe Gen1 and Gen2) and a 128b130b path (for PCIe Gen3 to Gen5). Depending on the path, code-group (COMMA) alignment or block alignment is done. The logic executing the 8b10b decoder is combined in block “PCS RX”. Both data streams are combined and forwarded to the PHY MAC block. Data are aligned to 8-bit symbol boundaries in 8b10b mode (symbols start at bit 0, 8, 16 or 24) and to blocks in 128b130b mode (a new block starts at bit 0, all following 32-bit chunks are aligned to bit 0 as well). In the TX direction of data flow, data from the PHY MAC block is processed in the “PCS TX” block. Data are split into two data paths: Gen1 and Gen2 data are 8b10b encoded, and Gen3 to Gen5 data are 128b130b encoded.

In the RX direction of the PHY MAC block, data are descrambled in the RX Lane block and forwarded to “rti2pfx” converting the “retimer internal bus” (rti) formatted data into a “PCS-Flexbus” (pfx) format used between the RPCS blocks. At the same time, the PCS data are forwarded to a training decoder. The “TX Align” block synchronizes switching between “Forward” mode and “Execution” mode. While in “Forward” mode data are taken from “TS Update” block (see below), while in “Execution” mode data are taken from a Training Control unit for Link Training.

In TX direction, some fields of the data are partially updated to inform subsequent blocks about retimer(s) presence in the data paths between the root complex and the endpoint. Such updates are performed in block “TS Update” which is part of the “TX Align” block. An additional Training Decoder block extracts data from the TX data stream so the retimer training status state machine (RTSSM) may observe control data from both directions. The RTSSM is the central controlling unit. It switches between “Forward” and “Execution” mode, controls link training, and observes the complete RPCS logic. The RTSSM may include various mode control logic block responsible for handling modes of operation including (i) transparent mode (ii) compute express link (CXL) mode, (iii) compliance load-board (CLB) mode and (iv) loopback (LPB) modes.

The Symbol Detection block extracts COM symbols as part of TS1/TS2 (8b10b) or SKP ordered sets or EIEOS ordered sets (128b130b) for Deskewing. The Deskew FIFO (Elastic Buffer) is used to perform lane-to-lane alignment (deskewing) as well as rate adaptation to compensate for small frequency offsets between receive and transmit clock. The Link Adjustment Control block controls deskewing and rate adaptation. It handles varying number of lanes to support bifurcation. For the full-flexible 8-lane mode and the D2D Transparent mode where data are fed through the D2D interface, the FIFO write side writes two words within one clock cycle at a lower frequency. After successful alignment this block starts by generating a EIEOS block(s) aligned with ordered set boundaries before it forwards data. The link adjustment block may stop data transmission and send EIOS blocks to terminate the data stream. Transmission of EIOS blocks is aligned with ordered set boundaries. The Link Adjustment block is also responsible for fetching data from the Elastic Buffer. Since the PCS-TX logic adds Sync-Header bits into the 128b130b data stream, it inserts idle cycles to compensate for bandwidth increase. Specifically, 128b130b inserts 2 bits every 128 bits, and thus an idle/inactive cycle may be inserted every 64 clock cycles). The Link Adjustment block also provides electrical idle information per symbol as sideband information. The electrical idle information is used by the attached PHY to generate an electrical idle on the high-speed serial TX lanes. The generation of the electrical idle sideband information is synchronized with the output data stream.

In some embodiments, control SKP ordered sets (C-SKP) may be utilized between devices to convey vendor-defined instructions in the form of e.g., data bytes or bits. While a SKP ordered set inserted by a transmitter in 8b10b encoding is represented as COM followed by three SKP symbols (the SKP symbols either padded and/or truncated by retimer devices in the data path), C-SKP ordered sets may include multiple bytes in the symbol at the end of the ordered set. I.e., instead of a COM-SKP-SKP-SKP, a C-SKP may take the form of COM-SKP-SKP-SKP′ where SKP′ includes vendor-defined information bits/bytes detectable by logic in the RPCS.

In at least one example, the C-SKP ordered sets may be utilized to switch the operational modes of a retimer, e.g., to switch from RPCS retimer mode to transparent mode and back, as described in [Sharma]. In such a scenario, the root complex may issue C-SKP that include a vendor-defined instruction to switch from the RPCS retimer mode to the transparent mode. The symbol detection logic may detect the vendor defined instruction within the C-SKP ordered sets in each data lane participating in an active PCIe data link and responsively the CPU may prepare to switch to the transparent mode of operation. When the root complex begins transmitting training ordered sets, the training ordered sets are detected in the RPCS logic and the CPU configures the data path to switch to the transparent mode of operation and the data link is established. In some embodiments, symbol detection logic (e.g., a “VDM decoder”) in the RPCS logic uses pattern detection to detect the C-SKP and determine the contents in the vendor-defined fields. The VDM decoder my flag an interrupt controller to issue an interrupt to the active CPU on the MCM, while simultaneously conveying the Tx-RPCS logic to begin transmitting electrical idle symbols on the data lanes. Responsive to the interrupt, the CPU may load new values into the configuration registers that contain the multiplexing control signals that are provided to the multiplexers involved in routing the data lanes from the lane routing logic to either the RPCS logic or through the low latency path. After the reconfiguration of the configuration registers, the link training procedure may bring PCIe data link back up using the transparent mode of operation.

While operating in the transparent mode, the VDM decoder in the RPCS logic may continue to receive inbound traffic in parallel to the transparent mode and may act in a snoop mode by decoding the data stream and searching the decoded data for a C-SKP ordered set to re-enter the RPCS retimer mode of operation. In such an embodiment, the RPCS decode logic and VDM decoder symbol detection logic may be enabled, while the RPCS FIFO and RPCS TX logic may be disabled to save power. Responsive to detecting a C-SKP ordered set containing a VDM for switching back to RPCS retimer mode, the RPCS logic may similarly notify the CPU on the leader tile of the retimer which may queue an action to reconfigure the retimer data path back to the RPCS logic responsive to the root complex reinitiating a link training procedure.

In addition to the commands to switch operational modes, the RPCS logic and of the retimer may be configured to modify the contents of the vendor-defined fields in a C-SKP. For example, at least one embodiment detects the C-SKP associated with switching to the transparent mode of operation, and responsively inserts transparent-mode skew configuration parameters into the vendor-defined fields of the C-SKP before relaying the C-SKP to the next retimer in a multi-retimer data link. In such an embodiment, the skew configuration parameters may contain e.g., delay buffer settings for transparent mode and/or lane routing configurations for reducing skew and/or latency from the root complex to the endpoint, described in more detail below.

The clock domain crossing (CDC) FIFO is a drift buffer allowing for transparent data forwarding from one PHY (PIPE interface) to the opposite PHY. The CDC FIFO performs clock domain crossing and may have a depth of four entries, however such a depth should not be considered limiting. The FIFO depth may be designed to be small to reduce latency but large enough to maintain sufficient distance between the read and write pointers so that the pointers do not collide.

### Multi-Lane Deskewing

Deskewing and rate adaptation are related to each other and are implemented in the same block (Deskew & Rate-Adjust Control). First the lane-to-lane skew is compensated. This process is also known as lane alignment and is typically done using a FIFO. For this purpose, alignment symbols are detected in the data stream. Due to the skew between lanes, these alignment symbols are received at different times in each lane. In the deskewing process, the received alignment symbols are stored into the FIFO and the location of these alignment symbols within the FIFO is also stored. This happens independently in all lanes using the recovered clocks of each lane independently. When the alignment symbols of all lanes are stored within their respective FIFOs, data is read from the FIFO starting from the read pointer defining the location where the alignment symbol was stored. On the read side this happens at the same time in all lanes with a common clock so that the first data output from the FIFO corresponds to the alignment symbols. The FIFO fill level is observed, and depending on the fill level, special data for rate adaptation is either inserted if the FIFO fill level is almost empty or removed if the FIFO level is almost full. In such a scenario, rate adaptation symbols are used for this purpose. When these rate adaptation symbols are seen at the same time in all lanes (which is the case after the deskewing process), the data can be either removed or duplicated (inserted) at the same time in all lanes. Rate adaptation is described in more detail below.

One challenge addressed below is that in retimer mode, all transmitters are synchronized to a common reference clock. However, in a retimer, it is typical that each data lane has its own read clock and that no common read clock is available. The read clock essentially corresponds to the transmit clock of the attached serializer.

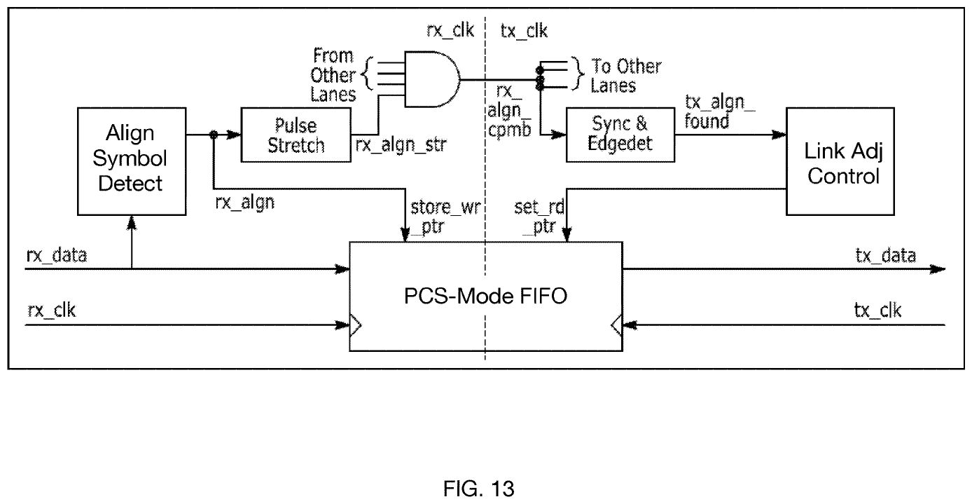

FIG. 13 is a block diagram illustrating the lane deskewing concept in a PCIe retimer circuit, in accordance with some embodiments. In some embodiments, a method for performing lane deskewing includes independently detecting an alignment symbol within a first-in-first-out (FIFO) buffer in each data lane according to a recovered clock signal rx_clk, and responsively generating a single cycle pulse rx_algn responsive to detection of the alignment symbol. Once the alignment symbol is stored, the location within the FIFO is also stored as a write pointer, which may include storing the start position of the alignment symbol. In some embodiments, the alignment symbol is a 32-bit symbol. It should be noted that since encoded data is stored in the FIFO, the block boundary continuously changes and thus the block boundary of the alignment symbol is stored as well. The method further includes independently generating a pulse rx_algn_str for each data lane, e.g., by stretching the alignment detection pulse rx_algn, indicating that the alignment symbol is in the FIFO. In some embodiments, the length of the pulse depends on the required deskewing capabilities. For example, when N is the maximum deskewing capability (in clock cycles), then the length of the pulse L=ceil(N+2). In such an embodiment, N is defined by the maximum input skew plus the skew introduced by the deserializer (which is bitwidth—1 UI) and the synchronizer. The stretched alignment pulses of all data lanes is asynchronously combined via an AND gate indicating that alignment symbols are stored in the FIFOs of all data lanes. It should be noted that since the read clocks of each data lane are independent, the AND combination is performed prior to synchronization. In some embodiment, the AND combination is built from instantiated tech cells to prevent glitches at the input of the synchronizer. In each data lane, the AND-ed signal rx_algn_comb is synchronized to the aligned transmit clock tx_clk. The rising edge of the synchronized signal is detected. Stretching the alignment pulse rx_algn_str as described above by two additional clock cycles beyond the required deskew capabilities ensures that even in a scenario that maximum skew is present between two data lanes, the remaining pulse width is at least two clock cycles long. Such a length is sufficient for secure clock domain crossing, as the clock domain changes from the rx_clk in the receiver to the tx_clk in the transmitter. In some embodiments, the FIFO read clocks of all lanes are aligned to a common reference clock in retimer mode. A single-cycle rising edge pulse output from the alignment control finite state machine (FSM) is used to set the read pointer of the FIFO to be equal to the stored write pointer, thus setting the current read location of the FIFO to be the location of the alignment symbol. As the rising edge pulse has been synchronized for all FIFOs, the read pointer update occurs at the same time in all FIFOs. Since encoded data is stored in the FIFO, alignment may include adjustment of an internal barrel shifter to accommodate for the different block boundary locations in different lanes. Furthermore, since the read clocks are independently aligned to the common reference clock, a minimum skew equal to a single clock cycle may continue to exist between the data lanes. Such a skew is accepted and within the transmit skew budged defined by the PCIe base specification. Alignment may cause a discontinuity in the data stream sent downstream. In some embodiments, a configuration bit selecting between outputting a fixed pattern (e.g., a high-speed 1010 pattern) or outputting previously received data, accepting the discontinuity. Once the lanes have been deskewed, reading from the FIFOs continues and the alignment symbols are output from all the FIFOs at the same time. In some embodiments, a barrel shifter may be used to adjust the effective FIFO read position so that reading begins with the sync header bits of the alignment symbol.

### Transparent Mode Skew Reduction Through PCS Retimer Mode

As transparent mode is intended to minimize latency, lane-to-lane skew measurement functionality is typically not implemented within the transparent mode data path. However, embodiments described herein may obtain skew measurement values to reduce the lane-to-lane skew in the transparent mode. In such an embodiment, link training may be performed during the PCS retimer mode to determine the skew differences for each lane as described above, and then the system can utilize the measured skew differences to control skew within the transparent mode. In alternative embodiments, the skew measurement values may be loaded at startup from an instruction or data random access memory (RAM). In such embodiments, the skew measurement values may have been obtained from the link training, or may be a set of default settings e.g., for a particular motherboard layout, etc.

Referring to FIG. 11, a retimer 1100 configured to reduce lane-to-lane skew in transparent mode is shown. As shown, the retimer includes physical coding sublayer (PCS) logic configured to decode a plurality of encoded data streams associated with respective lanes of a data link. The PCS data path 1110 further includes a link adjustment circuit 1115 configured to perform lane deskew and rate adaptation on the decoded data streams. As shown, the link adjustment circuit includes PCS-mode FIFOs configured to store each decoded data stream, symbol detection logic configured to detect alignment symbols in each of the plurality of decoded data streams, and a link adjustment control circuit configured to synchronously set read pointers of the PCS-mode FIFO for each lane to positions corresponding to the detected alignment symbols and to calculate a set of lane-to-lane skew parameters based at least in part on latency of each PCS-mode FIFO, the latency of each PCS-mode FIFO associated with read pointer location with respect to a corresponding write pointer. The retimer 1100 further includes a central processing unit (CPU) configured to detect a command to switch from PCS-mode 1110 to a transparent mode of operation 1105, wherein each of the plurality of encoded data streams are routed to respective low-latency CDC FIFOs configured to store the encoded data streams using respective write clocks and to output encoded data streams based on corresponding read clocks, each read clock synchronized to a corresponding write clock. The transparent data path 1105 also includes delay buffers connected to outputs of each low-latency CDC FIFOs configured to adjust a timing of a first encoded data stream relative to a second encoded data stream based on the set of lane-to-lane skew parameters generated in the PCS-mode to reduce lane-to-lane skew.

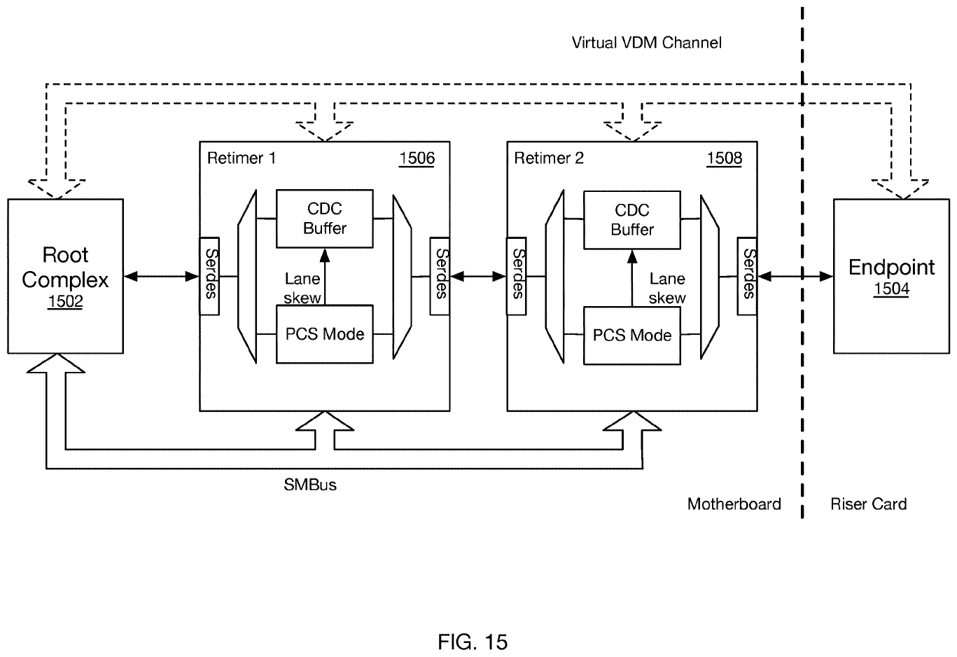

FIGS. 15 and 16 are block diagrams of system environments, in accordance with some embodiments. As shown in FIG. 15, a root complex communicates with an endpoint on a riser card via a path that includes two retimer circuits. Similarly, FIG. 16 also includes two retimer circuits, however one of the retimers is contained within the riser card. As shown, the root complex, retimers, and endpoint may exchange configuration information with each other over a system management bus (SMBus) or a virtual vendor-defined message (VDM) channel that utilizes the sideband of the physical links between each device. Each retimer is shown as being configured in multiple protocols, specifically the PCS retimer mode and transparent mode using the CDC buffer, however it should be noted other protocols not shown may be included as well. One will appreciate that multiple retimers extend the length of the link, and embodiments described herein describe methods for reducing lane-to-lane skew in the transparent mode of operation.

In some embodiments, during a link training procedure, lane-to-lane skew information may be determined utilizing the above-described process while in the PCS retimer mode. As described, the read pointers of every data lane are synchronously set to the locations of the alignment symbols within the respective data lane, and information is output from the FIFO's with skew having been corrected. While skew has been corrected in the PCS retimer mode via the setting of the read pointers in PCS-mode FIFOs, additional steps herein may be taken to perform a measurement of lane-to-lane skew such that the measurements may be utilized by the low-latency CDC FIFOs to reduce lane-to-lane skew during transparent mode. As the read pointers are synchronously set in each data lane to the locations containing the alignment symbols, lane-to-lane skew information may be obtained by analyzing the FIFO fill level and FIFO depth of the PCS-mode FIFOs in the PCS retimer data path. Specifically, for each lane, the FIFO fill level may be observed by analyzing the read pointer value when the write pointer wraps, and the latency in each FIFO may be determined by comparing the location of the read pointer relative to the overall FIFO depth. A specific example is as follows and assumes a 16-word FIFO (e.g., having addresses from 0 to 15) in which pointer values are incremented to the maximum address value before wrapping back down to the minimum address value. It should be noted that such a FIFO size should not be considered limiting and is only for illustrative purposes. In data lane_1, the write pointer wraps to zero, which may be detected in some embodiments e.g., by the most significant bit of the write pointer toggling to 0. The read pointer address is analyzed, which may correspond e.g., to an address 0100, or ‘4’. Thus, the latency of the FIFO, i.e., the number of clock cycles information is stored in the FIFO before being read out corresponds to the maximum FIFO address (i.e., the FIFO_depth as the address ranges from ‘0’ to ‘16’) minus the read pointer address, i.e., 15−4=11. In data lane_2, the read pointer address may be 1000, or '8′when the write pointer wraps, and thus the latency of the FIFO in data lane_2 is 7. Thus, a lane-to-lane skew of 11−7=4 exists between lane_1 and _2, with lane_2 being the slower lane, indicating that lane_1 is the faster lane relative to lane_2 as the latency is greater in the low-latency CDC FIFO of lane_1 relative to the latency in the low-latency CDC FIFO of lane_2. The skew configuration logic may then configure the transparent mode low-latency CDC buffer in lane_1 to output data having a four clock cycle delay such that the output data of lanes_1 and _2 are aligned. In some embodiments, due to any jitter caused by clock domain crossing, the value of the FIFO latency may be low-pass filtered by low-pass filtering the read pointer value over several write pointer wraps for each lane. In alternative embodiments involving multiple retimers, lane routing via the raw MUX may be utilized to reduce skew as well, described in more detail below.

FIG. 11 is a block diagram of a retimer configured to reduce lane-to-lane skew in transparent mode, in accordance with some embodiments. As shown in FIG. 11, delay buffers are connected to the outputs of the CDC buffers of each lane. The delay buffers may be configurable to delay the faster lanes relative to the slowest lanes such that the data for each lane is properly aligned at the output of the transmitters of each lane. As the latency of a retimer is determined by the delay in the slowest lane, realigning the faster lanes does not impact the overall latency, and may reduce the size of the buffer in the endpoint if the data is aligned, or more generally ensure that the data lanes stay within the maximum allowed skew tolerance of the receiver. The skew information ‘skew_config’ is obtained from the lane adjustment control logic that operates on the read and write pointers of the RPCS layer and is provided to the delay lines connected to the outputs of the CDC buffers in each lane.

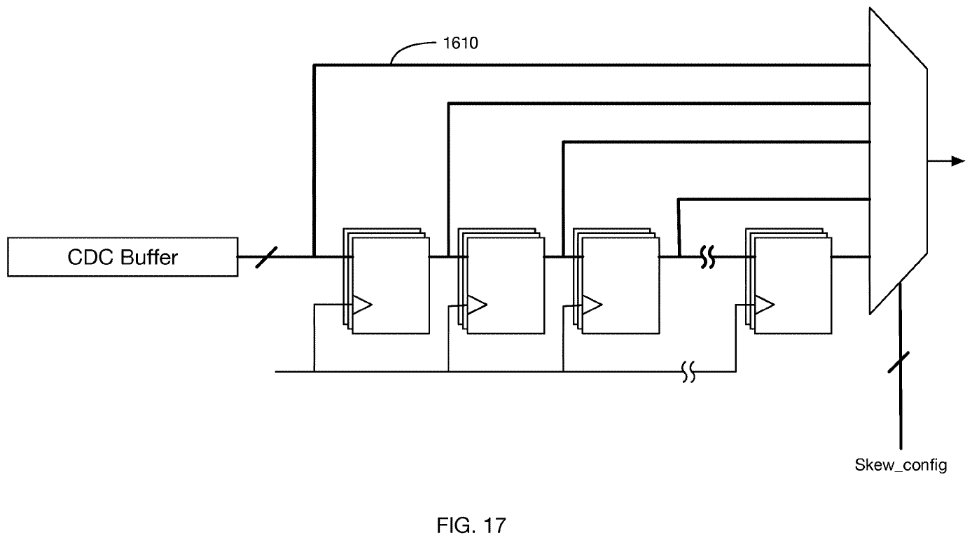

FIG. 17 is a block diagram of a delay buffer connected to the output of a CDC buffer used in transparent mode, in accordance with some embodiments. As shown, the data output, which may be e.g., a 16-bit or 32-bit word depending on the current protocol, is provided to a series of flip-flops, each clocked by the transmit clock tx_clk. The multiplexer shown has inputs connected to the outputs of the series of flip-flops. The input selection of the multiplexer is performed by the skew_config signal obtained from the lane deskew process. In some embodiments, control logic (not shown) may be configured to set the multiplexer of the slowest lane to take the lowest-delay output 1610, and may configure the multiplexers of the faster lanes with skew_config signals to select one of the outputs delayed by the flip-flops by an amount determined from the offset between the alignment symbol read pointer for the faster lanes relative to the alignment symbol read pointer of the slowest lane. In PCIe 5.0, the maximum amount of skew between lanes is 5 ns. As shown in FIG. 17, each flip flop is clocked by a 1 GHz tx_clk and thus in such an embodiment, a series of five flip flop stages may be used. Each flip-flop stage in the chain delays a 32-bit output word by Ins. In such an embodiment, the lane-to-lane skew may be reduced in a given PCIe retimer operating in transparent mode to be within one word, i.e., 1 ns. An alternative embodiment, (not shown) may utilize the rising edge and falling edge of the tx_clk to add an additional 0.5 ns of resolution. It should be noted, however, that in such embodiment the transmitter should include e.g., a state machine, for outputting data according to the rising or falling edge of the tx_clk as well. In such an embodiment, a series of 10 flip-flops may be used to account for the maximum 5 ns of skew between lanes. If sub-word lane-to-lane deskew is desired, methods for sub-word deskew described above may be combined with the embodiments described herein.

As shown in FIGS. 15 and 16, the use of multiple retimers suggests that the distance between the root complex and the endpoint on e.g., a motherboard is further than a single retimer supports. In such embodiments, a similar approach of reducing the lane-to-lane skew in transparent mode may be performed, with some additional configurations. In some embodiments, retimer_1 and retimer_2 may collaborate on skew configuration settings. Such embodiments may include modifying the amount of delay applied to each lane via the skew_config signals provided to the multiplexers, as well as data lane routing via the raw MUX between multiple retimers in the data link between the root complex and the endpoint.

The following scenarios consider a data link having two data lanes for simplicity; however, the methods described below are extendable to data links having a larger number of data lanes. In a first scenario, lane_1 may have a relative delay of three clock cycles with respect to lane_2 for retimer 1, and lane_1 of retimer 2 may also have a delay of three clock cycles with respect to lane_2 in retimer 2. In such an embodiment, retimer 1 and retimer 2 may agree to re-route the data inbound from the root complex to retimer 1 from lane_1 to be output on lane_2 and vice versa, so that both streams of data experience a latency of three clock cycles.

In a second scenario, lane_1 of retimer_1 may have a delay of two clock cycles with respect to lane_2 of retimer_1, and lane_2 of retimer_2 may have a delay of two clock cycles with respect to lane_1 of retimer_2. In such a scenario, rather than delaying lanes in both retimers, the latency is reduced if no delays are added to each lane.

In some embodiments, the raw MUX routing and delays for each lane in each retimer may be calibrated to maintain a lowest maximum delay, while also compensating for skew between each data stream as seen by the endpoint, thus reducing the required buffer size in the endpoint and additional processing latency. Such embodiments may utilize a combination of lane routing configurations via the raw mux and delay values applied to the delay lines connected to the CDC buffers that create a worst-case data path having a minimized worst-case latency, while the remaining data paths are normalized to the latency of the worst-case data path using the flip-flop buffers connected to the CDC buffers. In some embodiments, lane rerouting may act as a coarse skew correction in that the largest amount of delay for a given data lane in the data link is minimized. Subsequently, a fine skew correction via the delay buffers may be applied to reduce any remaining skew between the data lanes.

Referring back to FIG. 15, a method for configuring lane routing parameters is as follows. During a link training procedure, the lane-to-lane skew may be determined for the (i) lanes between the root complex and retimer 1 utilizing the techniques described above. The PCS-mode FIFOs may compensate for the lane-to-lane skew and transmit the data from retimer 1 to retimer 2, where again the lane-to-lane skew may be determined (ii) between the two retimers using the above techniques. If supported, the lane-to-lane skew between retimer 2 and the endpoint may be determined as well, however such a scenario is not required.

After finding the lane-to-lane skew are measured for (i) and (ii), the skew measurements may be conveyed to a processor to determine an optimal lane routing configuration based on the measured lane-to-lane skew settings. In such embodiments, the processor may be included in the root complex, a board management controller, or may be contained e.g., as part of one of the retimers. In a multi-retimer data link, one of the retimers may be designated as a leader retimer, similar to the way one of the CPUs of a multi-die retimer is designated as the leader CPU.

In some embodiments in which the retimers performing transparent mode skew compensation are all located on the same PCB, the lane-to-lane skew settings may be conveyed using the SMBus. In an environment in which one or more retimers are located off-board, e.g., on a riser card, etc, then C-SKPs with vendor-defined fields may be used to exchange the skew parameters for each set of data lanes. As described above, symbol detection logic in the RPCS retimer data path may be utilized to detect vendor-defined instructions within the vendor-defined fields of a C-SKP ordered set to switch modes of operation. In addition, the vendor-defined fields may be updated to convey skew configuration parameters to determine optimal delay buffer and/or lane routing settings used in transparent mode.

As the outputs of the CDC FIFOs in the transparent mode are multi-bit words, it may be plausible that some skew exists between lanes on a bit-level in addition to any word-level skew. In such embodiments, the skew may be further reduced on the bit-level resolution. In one embodiment, the PHY may include the functionality of ‘bit-slipping’ as described above. In such embodiments, bit-level skew may be reduced between lanes by slipping the receiver clocks by one bit over several steps so that the receiver clocks are aligned.

FIG. 15 illustrates a use case scenario where multiple PCIe retimers are placed on a motherboard, and the endpoint may be e.g., a riser card inserted into a slot connected to the motherboard. In such an environment, the system management bus (SMBus) may be a physical bus used to convey lane-to-lane deskew and routing information between the root complex (e.g., CPU) and the retimers. It should be noted that additional PCIe retimers may be included on the motherboard, depending on the overall distance between the root complex and the endpoint.

FIG. 16 is another use case scenario where the endpoint riser card includes a PCIe retimer. In such an environment, the SMBus may not extend to the riser card slot, and thus information may be carried as side-band information in the data flow between the root complex and endpoint. In such an embodiment, the side-band information may correspond to vendor-defined messages (VDMs) and may thus act as a virtual channel (i.e., no dedicated wires for the VDMs) on the data flow between the root complex and endpoint. The VDMs may be carried via control skip ordered sets used for rate adaption, and the VDMs may be detected locally within the PCIe retimers to configure buffer settings to reduce lane-to-lane skew. Additionally, the control skip ordered sets may also configure the raw MUX in each PCIe retimer to set the lane routing between the retimer circuits.

For multi-tile retimer circuits, lane-to-lane skew information may be communicated locally via tiles. In such embodiments, the lane-to-lane skew information may be communicated via the SPI interface. In alternative embodiments, the lane-to-lane skew information may be communicated as side-band information on the high-speed die-to-die interconnect.

In some embodiments, the skew configuration settings may be stored in a readable instruction memory. In such embodiments, the skew configuration settings may correspond to initial skew configuration settings associated with e.g., a particular manufacturer's motherboard identified by a serial number, and thus the trace layout between retimers is known. Such embodiments may perform skew analysis as described above using the PCS retimer mode during link training and overwrite the initial skew configuration settings with the measured skew configuration settings, as factors such as process variation within the retimers may have some effects on lane-to-lane skew. In some embodiments, the skew configuration settings are signed with a private key, and may be authenticated during the boot process with the public key stored in the boot loader. In such embodiments, in-field updates may be made to skew configurations.

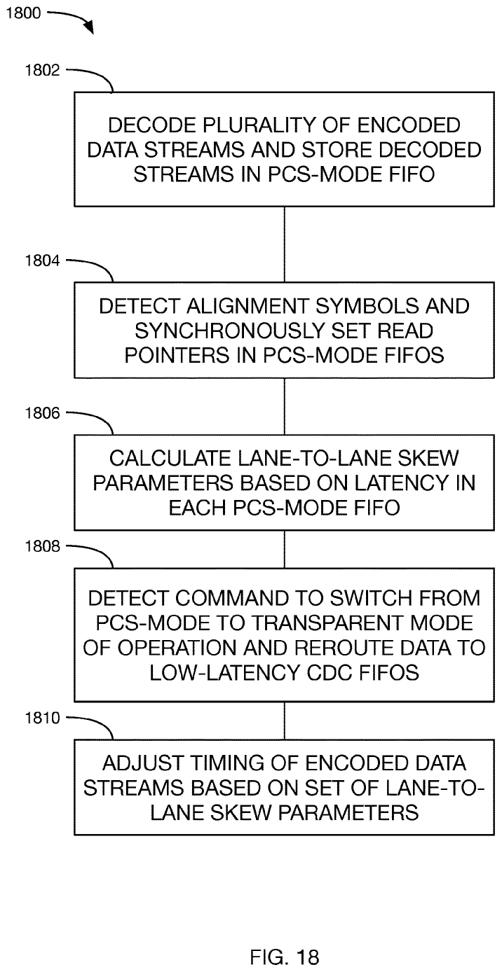

FIG. 18 is a flowchart of a method 1800, in accordance with some embodiments. As shown, method 1800 includes decoding 1802 a plurality of encoded data streams associated with respective lanes of a data link and storing each decoded data stream in corresponding PCS-mode FIFOs configured to perform lane deskew and rate adaptation on the decoded data streams. In some embodiments, the decoding includes performing 8b10b decoding while operating according to PCIe generations 1 and 2. In some embodiments, the decoding includes performing 128b130b decoding while operating according to PCIe generations 3 through 5.

The method further includes detecting 1804 alignment symbols in each of the plurality of decoded data streams, and synchronously setting read pointers of the PCS-mode FIFOs in each lane to positions corresponding to the detected alignment symbols.

The method further includes calculating 1806 a set of lane-to-lane skew parameters based at least in part on latency of each PCS-mode FIFO, the latency of each PCS-mode FIFO associated with read pointer location with respect to a corresponding write pointer. In some embodiments, calculating the set of lane-to-lane skew parameters comprises storing the read pointer location of each lane responsive to the corresponding write pointer wrapping, and determining the latency of the PCS-mode FIFO by comparing the stored read pointer location to a depth of the PCS-mode FIFO. In such embodiments, the FIFO latency in each PCS-mode FIFO may be calculated to determine how many clock cycles effectively separate the read pointer from the write pointer. In other words, how many clock cycles it takes for a word to be read out of the FIFO after the word was written into the FIFO. The difference in the FIFO latencies between lanes corresponds to a lane-to-lane skew value due to the synchronization of the read pointers in each FIFO to begin reading from the alignment symbol in each lane. As each lane has been aligned via the read pointers, then the FIFO latency determines the lane-to-lane skew.

The method further includes detecting 1808 a command to switch from PCS-mode to a transparent mode of operation, wherein each of the plurality of encoded data streams are routed to respective low-latency CDC FIFOs configured to store the encoded data streams using respective write clocks and to output encoded data streams based on corresponding read clocks, each read clock synchronized to a corresponding write clock. In some embodiments, the command may be obtained from e.g., a root complex CPU via the system management bus. In some embodiments, the command may be extracted as a vendor-defined message contained within e.g., control skip ordered sets.

The method further includes adjusting 1810 a timing of a first encoded data stream relative to a second encoded data stream based on the set of lane-to-lane skew parameters generated in the PCS-mode to reduce lane-to-lane skew. In some embodiments, adjusting the timing of the first encoded data stream relative to the second encoded data stream comprises adjusting transmit times of the first and second encoded data streams by e.g., adjusting a phase of the transmit clock in each lane. In another embodiment, the output of each low-latency CDC FIFO is connected to a respective delay line and adjusting the transmit times of the first and second encoded data streams includes selecting an output from each delay line according to the set of lane-to-lane skew parameters. Each tap of the delay line may be an input to a multiplexer, and a skew control signal is provided to the selection input of the multiplexer. In such an embodiment, each delay line may include a plurality of pipeline flip-flops, where each flip-flop has an output connected to a respective input of a multiplexer. In some embodiments, if the depth of the FIFO is sufficient, the adjustment of the transmit times of the first and second encoded data streams may be done by adjusting the read pointers of the low-latency CDC FIFOs configured to store the first and second encoded data streams.

In some embodiments, the lane-to-lane skew between data lanes may be measured for the root complex to the retimer and separately for the retimer to the endpoint (or another retimer). In such an embodiment, the timing adjustment between the first and second encoded data streams may be done based on a lane routing configuration of the data streams using e.g., the multiplexing crossbar switch.

In some embodiments, a method includes operating in a skew detection mode by: receiving PCS encoded data via data lanes of a multiple lane PCIe link, generating decoded data by decoding the PCS encoded data of each lane using a PCS decoder, writing the decoded data to a set of FIFOs having a first fill depth level for the decoded data to cross from an RX clock domain to a TX clock domain, and determining lane-to-lane skew values based at least in part on differences between FIFO locations containing start symbols. After lane-to-lane skew values are determined, the method includes subsequently operating in a low latency mode by receiving PCS encoded data via data lanes of a multiple lane PCIe link and bypassing the PCS decoder, writing the encoded data to a set of FIFOs having a second fill depth level lower than the first fill depth level for the encoded data to cross from an RX clock domain to a TX clock domain where the TX clock domain is frequency locked to the RX clock domain, and delaying at least one lane of the multiple lane PCIe link based on the lane-to-lane skew values.

We claim:

1. A method comprising:
decoding, during a skew measurement mode, a plurality of encoded data streams associated with respective lanes of a data link and storing each decoded data stream in corresponding PCS first in first out buffers (FIFOs);
detecting alignment symbols in each of the plurality of decoded data streams, and synchronously setting read pointers of the PCS FIFOs in each lane to positions corresponding to the detected alignment symbols;
calculating a set of lane-to-lane skew parameters based at least in part on a latency of each PCS FIFO, the latency of each PCS FIFO associated with a read pointer location with respect to a corresponding write pointer;
detecting a command to switch from the skew measurement retimer mode to a transparent mode of operation, responsively routing each of the plurality of encoded data streams to respective low-latency CDC FIFOs configured to store the encoded data streams using respective write clocks and outputting the encoded data streams based on corresponding read clocks, each read clock synchronized to a corresponding one of the respective write clocks; and
adjusting a timing of a first encoded data stream relative to a second encoded data stream based on the set of lane-to-lane skew parameters generated in the skew measurement mode to reduce lane-to-lane skew.

2. The method of claim 1, further comprising storing the read pointer location of the PCS FIFO of each lane responsive to the corresponding write pointer wrapping and determining the latency of each PCS FIFO by comparing the stored read pointer location to a depth of the PCS FIFO.

3. The method of claim 1, wherein adjusting the timing of the first encoded data stream relative to the second encoded data stream comprises adjusting transmit times of the first and second encoded data streams.

4. The method of claim 3, wherein each low-latency CDC FIFO is connected to a respective delay buffer, and wherein adjusting the transmit times of the first and second encoded data streams comprises selecting an output from each delay buffer according to the set of lane-to-lane skew parameters.

5. The method of claim 4, wherein each delay buffer comprises a plurality of pipeline flip-flops (FF), each FF having an output connected to a respective input of a multiplexer, and wherein the output from a given delay buffer is selected via a selection signal provided to the input of the multiplexer.

6. The method of claim 1, wherein adjusting the timing of the first encoded data stream relative to the second encoded data stream comprises setting a lane routing configuration of each encoded data stream to the respective low-latency CDC FIFO according to the set of lane-to-lane skew parameters, the lane routing configuration corresponding to a mapping of an input transceiver port to an output transceiver port.

7. The method of claim 1, further comprising measuring skew between the respective write clocks used to store the encoded data streams in the low-latency CDC FIFOs, and the timing of the first encoded data stream relative to a second encoded data stream is further based on the measured skew between the respective write clocks.

8. The method of claim 7, wherein the timing of the first encoded data stream relative to a second encoded data stream is adjusted by bit-slipping a receive port of a serial data transceiver based on the measured skew between the respective write clocks.

9. The method of claim 7, wherein the timing of the first encoded data stream relative to a second encoded data stream is adjusted by phase-adjusting the respective write clocks.

10. The method of claim 7, wherein the timing of the first encoded data stream relative to a second encoded data stream is adjusted via a transmit time in a transmit port of a serial data transceiver.

11. An apparatus comprising:
A physical coding sublayer (PCS) configured to decode, during a skew measurement mode, a plurality of encoded data streams associated with respective lanes of a data link;
a link adjustment circuit configured to perform lane deskew and rate adaptation on the decoded data streams, the link adjustment circuit comprising:
PCS first in first out buffers (FIFOs) configured to store each decoded data stream;
symbol detection logic configured to detect alignment symbols in each of the plurality of decoded data streams; and
a link adjustment control circuit configured to synchronously set read pointers of the PCS FIFO for each lane to positions corresponding to the detected alignment symbols and to calculate a set of lane-to-lane skew parameters based at least in part on latency of each PCS FIFO, the latency of each PCS FIFO associated with a read pointer location with respect to a corresponding write pointer;
a central processing unit (CPU) configured to detect a command to switch from the skew measurement mode to a transparent mode of operation, wherein each of the plurality of encoded data streams are routed to respective low-latency CDC FIFOs configured to store the encoded data streams using respective write clocks and to output encoded data streams based on corresponding read clocks, each read clock synchronized to a corresponding write clock; and
delay buffers connected to outputs of each low-latency CDC FIFOs configured to adjust a timing of a first encoded data stream relative to a second encoded data stream based on the set of lane-to-lane skew parameters generated in the PCS to reduce lane-to-lane skew.

12. The apparatus of claim 11, wherein the link adjustment control circuit is further configured to store the read pointer location of the PCS FIFO of each lane responsive to the corresponding write pointer wrapping, and to determine the latency of each PCS FIFO by comparing the stored read pointer location to a depth of the PCS FIFO.

13. The apparatus of claim 11, further comprising serial data transceivers, and wherein the timing of the first encoded data stream relative to the second encoded data stream by further adjusted by the serial data transceivers via transmit times of the first and second encoded data streams.

14. The apparatus of claim 13, wherein the delay buffers are configured to adjust the transmit times of the first and second encoded data streams via an output selection from each delay buffer according to the set of lane-to-lane skew parameters.

15. The apparatus of claim 14, wherein each delay buffer comprises a plurality of pipeline flip-flops (FF), each FF having an output connected to a respective input of a multiplexer, and wherein the output selection from a given delay buffer is selected via a selection signal provided to the input of the multiplexer.

16. The apparatus of claim 11, further comprising lane routing logic, and wherein the timing of the first encoded data stream relative to the second encoded data stream is further adjusted based on a lane routing configuration provided to the lane routing logic, the lane routing configuration corresponding to a mapping of an input transceiver port to an output transceiver port.

17. The apparatus of claim 11, further comprising a clock skew measurement circuit configured to measure skew between the respective write clocks used to store the encoded data streams in the low-latency CDC FIFOs, and wherein the timing of the first encoded data stream relative to a second encoded data stream is further based on the measured skew between the respective write clocks.

18. The apparatus of claim 17, wherein the timing of the first encoded data stream relative to a second encoded data stream is adjusted by bit-slipping a receive port of a serial data transceiver based on the measured skew between the respective write clocks.

19. The apparatus of claim 17, wherein the timing of the first encoded data stream relative to a second encoded data stream is adjusted by phase-adjusting the respective write clocks.

20. The apparatus of claim 17, wherein the timing of the first encoded data stream relative to a second encoded data stream is adjusted via a transmit time in a transmit port of a serial data transceiver.
